(19) United States
(12) Patent Application Publication
(10) Pub. No.: US 2026/0241649 A1
(43) Pub. Date: Aug. 20, 2026

(54) METHOD OF MANUFACTURING PICKLEBALL PADDLE

(71) Applicant: MH Solutions, LLC, Irvine, CA (US)

(72) Inventor: YU-CHENG SHIH, Taichung City (TW)

(21) Appl. No.: 19/056,317

(22) Filed: Feb. 18, 2025

(51) Int. Cl. B29C 70/68; B29C 70/22; B29C 70/42; B29L 31/52

(52) U.S. Cl. CPC B29C 70/682; B29C 70/222; B29C 70/42; B29L 2031/5245

(57) ABSTRACT

A method of manufacturing a pickleball paddle, including following steps: preparing a core, the core including a head portion and a handle portion, a portion of the core where the head portion is connected with the handle portion defined as a connecting portion; surrounding an outer peripheral edge of the head portion with at least one edge strip; applying resin films to the core; applying at least one first reinforcement material to the connecting portion; applying two face sheets to two opposite sides of the core to form a pre-shaped structure; placing the pre-shaped structure in a mold and heating the mold to combine the core, the at least one edge strip, the resin films, the at least one first reinforcement material and the two face sheets; and cooling the pre-shaped structure to form the pickleball paddle, then removing the pickleball paddle from the mold.

### BACKGROUND OF THE INVENTION

### Field of the Invention

The present invention relates to a method of manufacturing a pickleball paddle.

### Description of the Prior Art

Pickleball is a racket sport that combines features of tennis, table tennis, and badminton. Pickleball blends elements such as the size of a badminton court, a tennis net, and a paddle similar to a table tennis racket. The design of pickleball paddles focuses on lightness and versatility, offering different weight categories: lightweight, medium weight, and heavyweight, allowing for a balance between agility and power.

However, after prolonged use, the junction between the paddle body and the handle is prone to stress concentration, which can lead to breakage, or the paddle face may become damaged due to the impact of the ball, causing users to frequently replace their paddles.

The present invention is, therefore, arisen to obviate or at least mitigate the above-mentioned disadvantages.

### SUMMARY OF THE INVENTION

The main object of the present invention is to provide a method of manufacturing a pickleball paddle, and the pickleball paddle provides good structural strength and durability.

To achieve the above and other objects, the present invention provides a method of manufacturing a pickleball paddle, including following steps: preparing a core, the core including a head portion and a handle portion, a portion of the core where the head portion is connected with the handle portion defined as a connecting portion; surrounding an outer peripheral edge of the head portion with at least one edge strip; applying resin films to two opposite sides of the core; applying at least one first reinforcement material to the connecting portion; applying two face sheets to two opposite sides of the core to form a pre-shaped structure; placing the pre-shaped structure in a mold and heating the mold at a predetermined temperature to combine the core, the at least one edge strip, the resin films, the at least one first reinforcement material and the two face sheets into an integrated piece; and cooling the pre-shaped structure in the mold to form the pickleball paddle, then removing the pickleball paddle from the mold.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a pickleball paddle according to a preferable embodiment of the present invention;

FIG. 2 is a breakdown drawing of a pre-shaped structure according to a preferable embodiment of the present invention;

FIG. 3 is a partial breakdown drawing of the pre-shaped structure according to a preferable embodiment of the present invention;

FIG. 4 is a cross-sectional view of a head of the pickleball paddle according to a preferable embodiment of the present invention;

FIG. 5 is an enlargement of FIG. 4;

FIG. 6 is a cross-sectional view of a handle of the pickleball paddle according to a preferable embodiment of the present invention; and

FIG. 7 is a flow chart of a preferable embodiment of the present invention.

### DETAILED DESCRIPTION OF THE PREFERRED EMBODIMENTS

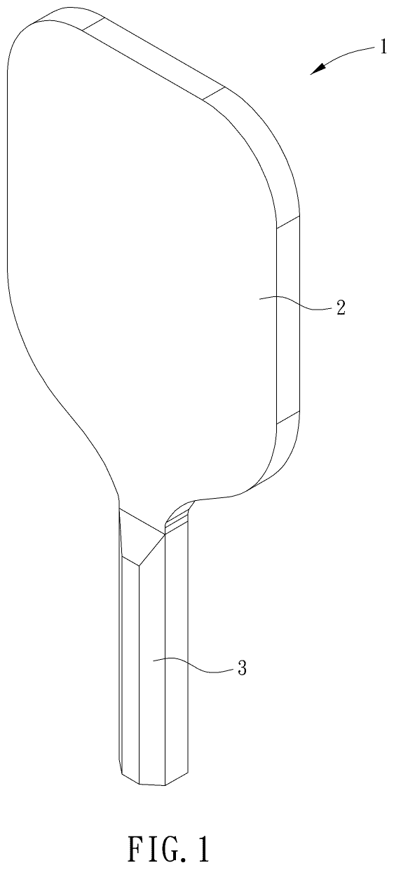

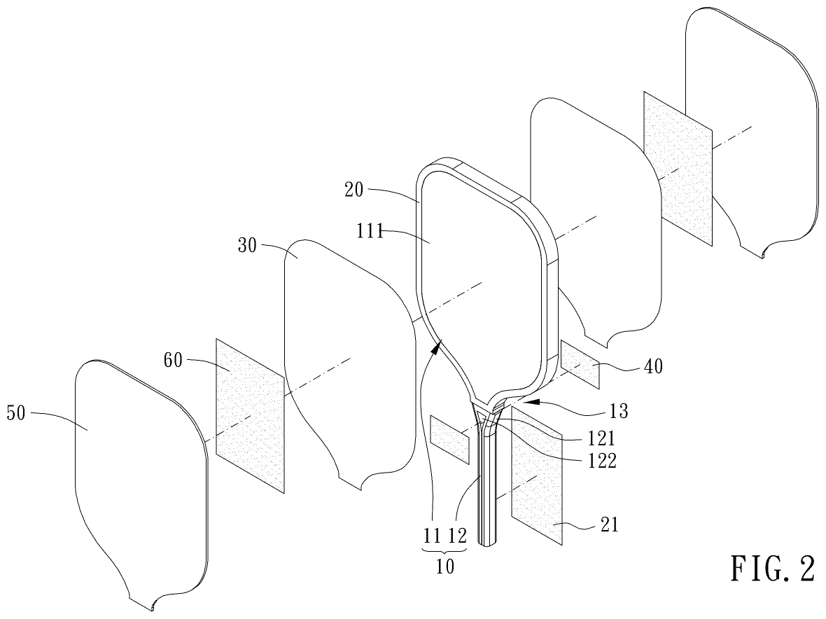

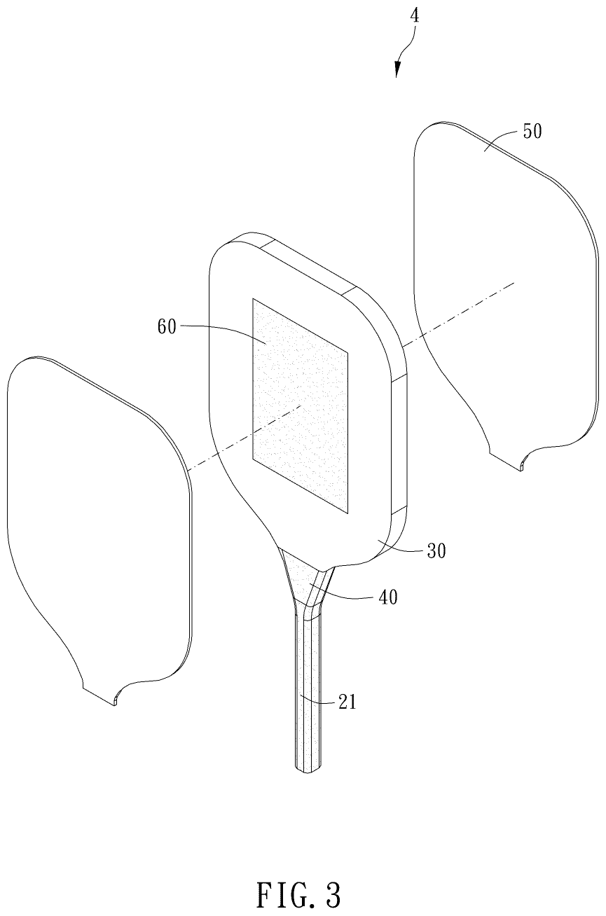

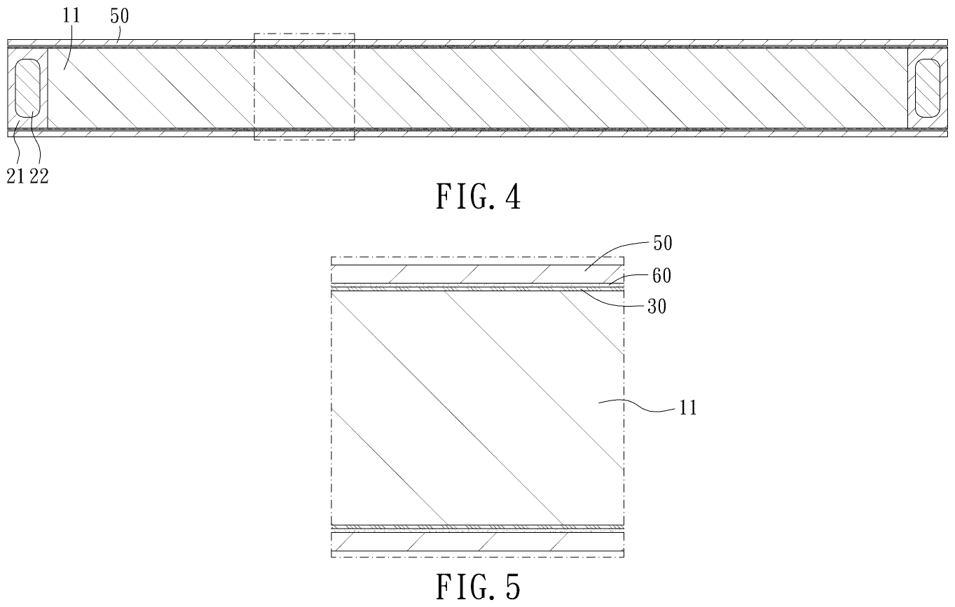

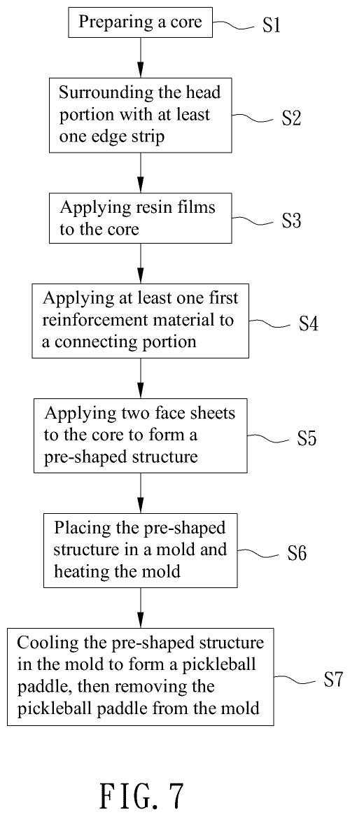

Please refer to FIGS. 1 to 7 for a preferable embodiment of the present invention. A method of manufacturing a pickleball paddle 1 of the present invention includes following steps.
Step 1 S1: Preparing a core 10. The core 10 includes a head portion 11 and a handle portion 12, and a portion of the core 10 where the head portion 11 is connected with the handle portion 12 defined as a connecting portion 13. In this embodiment, the head portion 11 and the handle portion 12 are made of different materials, and the handle portion 12 is formed of an inflatable tube. The inflatable tube is bent to form a throat portion 121 with an opening 122, and the throat portion 121 is connected with the head portion 11, which is easy to process and provides good structural strength after thermal forming. Specifically, the head portion 11 may be made of expanded polystyrene (EPS) foam material, expanded polypropylene (EPP) foam material, polyvinyl chloride (PVC) foam material, ethylene vinyl acetate (EVA) foam material, or polymethacrylimide (PMI) foam material, and the inflatable tube may be a nylon tube, which allows the pickleball paddle 1 to have light weight.
Step 2 S2: Surrounding an outer peripheral edge of the head portion 11 with at least one edge strip 20. The method further includes a step of wrapping at least one fibrous material 21 around a base strip 22 to form the at least one edge strip 20. In this embodiment, the base strip 22 is made of a foam material, the at least one fibrous material 21 includes carbon fibers; the outer peripheral edge of the head portion 11 is entirely surrounded by one said edge strip 20, and the head portion 11 is then connected with the handle portion 12. The at least one edge strip 20 may be attached to the outer peripheral edge of the head portion 11 by glue, tapes, or other bonding materials. The at least one edge strip 20 extending continuously provides lateral protection to the head portion 11 and enhances the structural strength and force transmission of the pickleball paddle 1.

In other embodiments, the head portion and the handle portion may be integrally formed as one piece from the same material, such as a foam material, and the at least one edge strip may be entirely arranged around an outer peripheral edge of the core, which also can make a pickleball paddle with light weight and good structural strength.
Step 3 S3: Applying resin films 30 to two opposite sides of the core 10. Preferably, the resin films 30 are flexible, and a material of the resin films 30 is selected from thermoplastic resins so as to stably connect the core 10, the at least one edge strip 20, and other components that come into contact with the resin films 30. Each of the resin films 30 may cover surfaces of the handle portion 12 and the head portion 11, or only cover a surface of the head portion 11, depending on manufacturing requirements.
Step 4 S4: Applying at least one first reinforcement material 40 to the connecting portion 13. Preferably, the at least one first reinforcement material 40 is entirely wrapped around the connecting portion 13 so as to increase the structural strength of the connecting portion 13. In this embodiment, two said first reinforcement materials 40 cover on two sides of the throat portion 121 and enclose the opening 122 so that the throat portion 121 is hollow after following processes.

It is noted that an order in which the resin films 30 and the at least one first reinforcement material 40 are layered onto surfaces of the core 10 is not limited. For example, the resin films 30 may be layered onto two opposite sides of the core 10 first, and then the at least one first reinforcement material 40 is layered onto the connecting portion 13 and overlapped with the resin films 30; or the at least one first reinforcement material 40 may be layered onto the connecting portion 13 first, and then the resin films 30 are layered onto two opposite sides of the core 10 and overlapped with the at least one first reinforcement material 40.
Step 5 S5: Applying two face sheets 50 to two opposite sides of the core 10 to form a pre-shaped structure 4. Preferably, each of the two face sheets 50 and each of the resin films 30 completely cover the head portion 11 and the at least one edge strip 20 as viewed in a thickness direction of the pre-shaped structure 4 so as to connect the head portion 11 and the at least one edge strip 20 and provide a smooth surface. The two face sheets 50 are made of a material including at least one of carbon fibers, glass fibers and Kevlar fibers so as to protect the head portion 11 in the thickness direction and be durable to use.

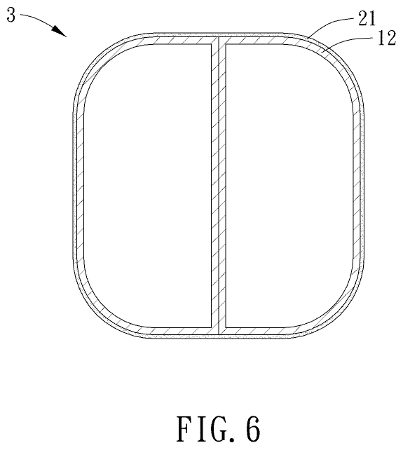

Before the step 5 S5, the method further includes a step of applying at least one second reinforcement material 60 to each of two face surfaces 111 of the head portion 11. The at least one second reinforcement material 60 covers at least 40% of an area of one of the two face surfaces 111 and is disposed on a middle of at least one of the two face surfaces 111. The middle of each of the two face surfaces 111 is an area frequently used for hitting a ball. With the at least one second reinforcement material 60, a head 2 of the pickleball paddle 1 is resistant to local deformation and abrasion, and is durable. Similarly, an order in which the resin films 30 and the at least one second reinforcement material 60 are layered onto the two face surfaces 111 is not limited. In this embodiment, each of the resin films 30 is arranged between one of the two face surfaces 111 and one said second reinforcement material 60, as shown in FIG. 5. The two face sheets 50 are arranged at outermost sides of the core 10, relative to the resin films 30 and said second reinforcement materials 60. In other embodiments, each said second reinforcement material may be arranged between one of the two face surfaces and one of the resin films.

Each said first reinforcement material 40 and each said second reinforcement material 60 are fibrous materials including carbon fibers. Carbon fibers can effectively enhance the tensile and compressive strength of the connecting portion and the two face surfaces 111, as well as reduce local deformation, inhibit the formation and propagation of cracks, thereby significantly improving the durability of the connecting portion and the head 2 of the pickleball paddle 1. Preferably, the method further includes a step of wrapping the at least one fibrous material 21 around the handle portion 12 to increase structural continuity and force transmission effect.
Step 6 S6: Placing the pre-shaped structure 4 in a mold and heating the mold at a predetermined temperature to combine the core 10, the at least one edge strip 20, the resin films 30, the at least one first reinforcement material 40 and the two face sheets 50 into an integrated piece. Specifically, the predetermined temperature is between 145° C. and 155° C., and a pressure between 3.0 kgf/cm² and 4.0 kgf/cm² is supplied into the mold during heating. However, the predetermined temperature and the pressure are adjustable according to the materials and the mold used.

Moreover, the step 6 S6 further includes steps of attaching a gas source to the inflatable tube and supplying gas to inflate the inflatable tube before heating the mold. Therefore, the inflatable tube can be expanded to fill a mold cavity of the mold and form a hollow handle 3 for the pickleball paddle 1, as shown in FIG. 6, which provides good structural strength and is lightweight.

Preferably, the method further includes a step of preheating the pre-shaped structure 4 at a temperature between 45° C. and 65° C. before the step of placing the pre-shaped structure 4 in the mold. With the preheating step, a heating time in the step 6 S6 can be reduced to increase processing efficiency.

Before the step 6 S6, the method further includes steps of wiping surfaces defining the mold cavity by a mold cleaner, heating the mold to a temperature between 140° C. and 150° C. for 10 to 15 minutes, and then removing any residue from the mold cavity. Then, apply a release agent to the surfaces defining the mold cavity before placing the pre-shaped structure 4 in the mold. The release agent may include HR-956 and methyl ethyl ketone (MEK) for easy movement of the pickleball paddle 1 in the following steps.
Step 7 S7: Cooling the pre-shaped structure 4 in the mold to form the pickleball paddle 1, then removing the pickleball paddle 1 from the mold. A cooling time depends on the environment temperature.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A method of manufacturing a pickleball paddle, including following steps:
preparing a core, the core including a head portion and a handle portion, a portion of the core where the head portion is connected with the handle portion defined as a connecting portion;
surrounding an outer peripheral edge of the head portion with at least one edge strip;
applying resin films to two opposite sides of the core;
applying at least one first reinforcement material to the connecting portion;
applying two face sheets to two opposite sides of the core to form a pre-shaped structure;
placing the pre-shaped structure in a mold and heating the mold at a predetermined temperature to combine the core, the at least one edge strip, the resin films, the at least one first reinforcement material and the two face sheets into an integrated piece; and
cooling the pre-shaped structure in the mold to form the pickleball paddle, then removing the pickleball paddle from the mold.

2. The method of manufacturing the pickleball paddle of claim 1, wherein the head portion and the handle portion are made of different materials, the outer peripheral edge of the head portion is entirely surrounded by the at least one edge strip, and the head portion is then connected with the handle portion.

3. The method of manufacturing the pickleball paddle of claim 1, wherein the handle portion is formed of an inflatable tube, the inflatable tube is bent to form a throat portion with an opening, and the throat portion is connected with the head portion.

4. The method of manufacturing the pickleball paddle of claim 3, further including steps of attaching a gas source to the inflatable tube and supplying gas to inflate the inflatable tube before heating the mold.

5. The method of manufacturing the pickleball paddle of claim 1, wherein the head portion and the handle portion are integrally formed as one piece from the same material, and the at least one edge strip is entirely arranged around an outer peripheral edge of the core.

6. The method of manufacturing the pickleball paddle of claim 1, further including a step of wrapping at least one fibrous material around a base strip to form the at least one edge strip.

7. The method of manufacturing the pickleball paddle of claim 1, further including a step of applying at least one second reinforcement material to each of two face surfaces of the head portion.

8. The method of manufacturing the pickleball paddle of claim 7, wherein the at least one second reinforcement material covers at least 40% of an area of one of the two face surfaces.

9. The method of manufacturing the pickleball paddle of claim 7, wherein each said first reinforcement material and each said second reinforcement material are fibrous materials including carbon fibers.

10. The method of manufacturing the pickleball paddle of claim 1, further including a step of preheating the pre-shaped structure at a temperature between 45° C. and 65° C. before the step of placing the pre-shaped structure in the mold.

11. The method of manufacturing the pickleball paddle of claim 1, further including steps of wiping surfaces defining a mold cavity of the mold by a mold cleaner, heating the mold to a temperature between 140° C. and 150° C. for 10 to 15 minutes, and then removing any residue from the mold cavity.

12. The method of manufacturing the pickleball paddle of claim 1, wherein the predetermined temperature is between 145° C. and 155° C., and a pressure between 3.0 kgf/cm² and 4.0 kgf/cm² is supplied into the mold during heating.

13. The method of manufacturing the pickleball paddle of claim 1, wherein the two face sheets are made of a material including at least one of carbon fibers, glass fibers and Kevlar fibers.

14. The method of manufacturing the pickleball paddle of claim 1, wherein at least a portion of the core is made of expanded polystyrene (EPS) foam material, expanded polypropylene (EPP) foam material, polyvinyl chloride (PVC) foam material, ethylene vinyl acetate (EVA) foam material, or polymethacrylimide (PMI) foam material.

15. The method of manufacturing the pickleball paddle of claim 4, wherein the head portion and the handle portion are made of different materials, the outer peripheral edge of the head portion is entirely surrounded by one said edge strip, and the head portion is then connected with the handle portion; the head portion is made of expanded polystyrene (EPS) foam material, expanded polypropylene (EPP) foam material, polyvinyl chloride (PVC) foam material, ethylene vinyl acetate (EVA) foam material, or polymethacrylimide (PMI) foam material, and the inflatable tube is a nylon tube; the method of manufacturing the pickleball paddle further includes a step of wrapping at least one fibrous material around a base strip to form the at least one edge strip, wherein the base strip is made of a foam material, and the at least one fibrous material includes carbon fibers; the method of manufacturing the pickleball paddle further includes a step of applying at least one second reinforcement material to each of two face surfaces of the head portion, and wrapping the at least one fibrous material around the handle portion; the at least one second reinforcement material covers at least 40% of an area of one of the two face surfaces and is disposed on a middle of at least one of the two face surfaces; each said first reinforcement material and each said second reinforcement material are fibrous materials including carbon fibers; the method of manufacturing the pickleball paddle further includes a step of preheating the pre-shaped structure at a temperature between 45° C. and 65° C. before the step of placing the pre-shaped structure in the mold; the method of manufacturing the pickleball paddle further includes steps of wiping surfaces defining a mold cavity of the mold by a mold cleaner, heating the mold to a temperature between 140° C. and 150° C. for 10 to 15 minutes, and then removing any residue from the mold cavity; applying a release agent to the surfaces defining the mold cavity before placing the pre-shaped structure in the mold; the predetermined temperature is between 145° C. and 155° C., and a pressure between 3.0 kgf/cm² and 4.0 kgf/cm² is supplied into the mold during heating; and the two face sheets are made of a material including at least one of carbon fibers, glass fibers and Kevlar fibers, and each of the two face sheets and each of the resin films completely cover the head portion and the at least one edge strip as viewed in a thickness direction of the pre-shaped structure.
